(19) United States
(12) Patent Application Publication
(10) Pub. No.: US 2007/0067798 A1
(43) Pub. Date: Mar. 22, 2007

(54) Hover-buttons for user interfaces

(75) Inventor: Frank J. Wroblewski, Gaithersburg, MD (US)

Correspondence Address: POTOMAC PATENT GROUP, PLLC, P. O. BOX 270, FREDERICKSBURG, VA, 22404, US

(73) Assignee: Hillcrest Laboratories, Inc., Rockville, MD (US)

(21) Appl. No.: 11/505,207

(22) Filed: Aug. 16, 2006

Related U.S. Application Data
(60) Provisional application No. 60/708,851, filed on Aug. 17, 2005.

(51) Int. Cl. H04N 5/445; G06F 13/00; G06F 3/00

(52) U.S. Cl. 725/37; 725/38; 725/47; 725/52; 725/53; 725/43

(57) ABSTRACT

Systems and methods according to the present invention address these needs and others by providing systems and devices for user interfaces that employ user interface objects.

### RELATED APPLICATION

This application is related to, and claims priority from, U.S. Provisional Patent Application Ser. No. 60/708,851 filed on Aug. 17, 2005, entitled “Hover-Buttons for a Zoomable Interface”, the disclosure of which is incorporated here by reference.

### BACKGROUND

This application describes, among other things, user interface objects as well as, systems and devices associated with user interfaces which employ such user interface objects.

Technologies associated with the communication of information have evolved rapidly over the last several decades. Television, cellular telephony, the Internet and optical communication techniques (to name just a few things) combine to inundate consumers with available information and entertainment options. Taking television as an example, the last three decades have seen the introduction of cable television service, satellite television service, pay-per-view movies and video-on-demand. Whereas television viewers of the 1960s could typically receive perhaps four or five over-the-air TV channels on their television sets, today's TV watchers have the opportunity to select from hundreds, thousands, and potentially millions of channels of shows and information. Video-on-demand technology, currently used primarily in hotels and the like, provides the potential for in-home entertainment selection from among thousands of movie titles.

The technological ability to provide so much information and content to end users provides both opportunities and challenges to system designers and service providers. One challenge is that while end users typically prefer having more choices rather than fewer, this preference is counterweighted by their desire that the selection process be both fast and simple. Unfortunately, the development of the systems and interfaces by which end users access media items has resulted in selection processes which are neither fast nor simple. Consider again the example of television programs. When television was in its infancy, determining which program to watch was a relatively simple process primarily due to the small number of choices. One would consult a printed guide which was formatted, for example, as series of columns and rows which showed the correspondence between (1) nearby television channels, (2) programs being transmitted on those channels and (3) date and time. The television was tuned to the desired channel by adjusting a tuner knob and the viewer watched the selected program. Later, remote control devices were introduced that permitted viewers to tune the television from a distance. This addition to the user-television interface created the phenomenon known as “channel surfing” whereby a viewer could rapidly view short segments being broadcast on a number of channels to quickly learn what programs were available at any given time.

Despite the fact that the number of channels and amount of viewable content has dramatically increased, the generally available user interface, control device options and frameworks for televisions has not changed much over the last 30 years. Printed guides are still the most prevalent mechanism for conveying programming information. The multiple button remote control with up and down arrows is still the most prevalent channel/content selection mechanism. The reaction of those who design and implement the TV user interface to the increase in available media content has been a straightforward extension of the existing selection procedures and interface objects. Thus, the number of rows in the printed guides has been increased to accommodate more channels. The number of buttons on the remote control devices has been increased to support additional functionality and content handling, e.g., as shown in FIG. 1. However, this approach has significantly increased both the time required for a viewer to review the available information and the complexity of actions required to implement a selection. Arguably, the cumbersome nature of the existing interface has hampered commercial implementation of some services, e.g., video-on-demand, since consumers are resistant to new services that will add complexity to an interface that they view as already too slow and complex.

In addition to increases in bandwidth and content, the user interface bottleneck problem is being exacerbated by the aggregation of technologies. Consumers are reacting positively to having the option of buying integrated systems rather than a number of segregable components. An example of this trend is the combination television/VCR/DVD in which three previously independent components are frequently sold today as an integrated unit. This trend is likely to continue, potentially with an end result that most if not all of the communication devices currently found in the household will be packaged together as an integrated unit, e.g., a television/VCR/DVD/internet access/radio/stereo unit. Even those who continue to buy separate components will likely desire seamless control of, and interworking between, the separate components. With this increased aggregation comes the potential for more complexity in the user interface. For example, when so-called “universal” remote units were introduced, e.g., to combine the functionality of TV remote units and VCR remote units, the number of buttons on these universal remote units was typically more than the number of buttons on either the TV remote unit or VCR remote unit individually. This added number of buttons and functionality makes it very difficult to control anything but the simplest aspects of a TV or VCR without hunting for exactly the right button on the remote. Many times, these universal remotes do not provide enough buttons to access many levels of control or features unique to certain TVs. In these cases, the original device remote unit is still needed, and the original hassle of handling multiple remotes remains due to user interface issues arising from the complexity of aggregation. Some remote units have addressed this problem by adding “soft” buttons that can be programmed with the expert commands. These soft buttons sometimes have accompanying LCD displays to indicate their action. These too have the flaw that they are difficult to use without looking away from the TV to the remote control. Yet another flaw in these remote units is the use of modes in an attempt to reduce the number of buttons. In these “moded” universal remote units, a special button exists to select whether the remote should communicate with the TV, DVD player, cable set-top box, VCR, etc. This causes many usability issues including sending commands to the wrong device, forcing the user to look at the remote to make sure that it is in the right mode, and it does not provide any simplification to the integration of multiple devices. The most advanced of these universal remote units provide some integration by allowing the user to program sequences of commands to multiple devices into the remote. This is such a difficult task that many users hire professional installers to program their universal remote units.

Some attempts have also been made to modernize the screen interface between end users and media systems. However, these attempts typically suffer from, among other drawbacks, an inability to easily scale between large collections of media items and small collections of media items. For example, interfaces which rely on lists of items may work well for small collections of media items, but are tedious to browse for large collections of media items. Interfaces which rely on hierarchical navigation (e.g., tree structures) may be speedier to traverse than list interfaces for large collections of media items, but are not readily adaptable to small collections of media items. Additionally, users tend to lose interest in selection processes wherein the user has to move through three or more layers in a tree structure. For all of these cases, current remote units make this selection processor even more tedious by forcing the user to repeatedly depress the up and down buttons to navigate the list or hierarchies. When selection skipping controls are available such as page up and page down, the user usually has to look at the remote to find these special buttons or be trained to know that they even exist. Accordingly, organizing frameworks, techniques and systems which simplify the control and screen interface between users and media systems as well as accelerate the selection process, while at the same time permitting service providers to take advantage of the increases in available bandwidth to end user equipment by facilitating the supply of a large number of media items and new services to the user have been proposed in U.S. patent application Ser. No. 10/768,432, filed on Jan. 30, 2004, entitled “A Control Framework with a Zoomable Graphical User Interface for Organizing, Selecting and Launching Media Items”, the disclosure of which is incorporated here by reference.

As mentioned in the above-incorporated application, various different types of remote devices can be used with such frameworks including, for example, trackballs, “mouse”-type pointing devices, light pens, etc. However, another category of remote devices which can be used with such frameworks (and other applications) is 3D pointing devices with scroll wheels. The phrase “3D pointing” is used in this specification to refer to the ability of an input device to move in three (or more) dimensions in the air in front of, e.g., a display screen, and the corresponding ability of the user interface to translate those motions directly into user interface commands, e.g., movement of a cursor on the display screen. The transfer of data between the 3D pointing device may be performed wirelessly or via a wire connecting the 3D pointing device to another device. Thus “3D pointing” differs from, e.g., conventional computer mouse pointing techniques which use a surface, e.g., a desk surface or mousepad, as a proxy surface from which relative movement of the mouse is translated into cursor movement on the computer display screen. An example of a 3D pointing device can be found in U.S. patent application Ser. No. 11/119,663, the disclosure of which is incorporated here by reference.

Of particular interest for this specification is how these remote devices interact with information and objects in a graphical user interface (GUI). A currently popular mechanism for interacting with objects in a GUI is the dropdown list. Typically a remote device moves a cursor over an object of interest and a dropdown list 200 appears as shown in FIG. 2. However, when working with a visual interface where it is desirable to be able to interact with any object at any time, these dropdown lists have certain drawbacks.

Firstly, a visual browser (or bookshelf view as seen in FIG. 3) maximizes the available space by displaying as many images as possible on a single user interface screen. In such a layout when a standard dropdown list becomes visible it can obscure substantial portions of the objects. This can hinder the user in being able to easily point and click to select the obscured objects, e.g., the object 210 located “behind” the dropdown list 200 in FIG. 2. Secondly, a typical dropdown list consists of items that are vertically short and packed together, however, when using a 3D pointing device to access dropdown lists, it is easy to over shoot the desired choice and instead accidentally select an undesired option. This can increase user frustration. Thirdly, a dropdown list typically requires a click to become visible. If a user changes his or her mind, it requires another click to make the dropdown list become invisible. The number of times a user clicks can become high and detract from the goal of having a simple user interface. Fourthly, dropdown lists are sometimes located in a menu bar separate from the object of interest. To select an object and then move the cursor off the object to a menu could require a selection state option to be added to the interface. This addition of a selection state option is not desirable in a zoomable interface since it adds undesirable complications to the user interface. Lastly, dropdown lists are hidden by definition. Therefore the user has to be trained regarding the existence of these dropdown lists in the interface and to which objects these dropdown lists apply. All of these drawbacks tend to complicate the interface and create a higher learning curve than desired for new users.

Thus, these drawbacks demonstrate that there is significant room for improvement in the area of handheld device interactions with GUIs, generally, and interactions between 3D pointers with zoomable GUIs using hover-buttons specifically.

### SUMMARY

Systems and methods according to the present invention address these needs and others by providing systems and methods for interacting with user-selectable objects in a graphical user interface.

According to one exemplary embodiment of the present invention, a method for interacting with primary and secondary user-selectable objects in a graphical user interface comprising the steps of: associating secondary user-selectable objects with primary user-selectable objects; displaying secondary user-selectable objects associated with a respective primary user-selectable object when the respective primary user-selectable object is selected; and selecting one of the secondary user-selectable objects when a cursor is proximate of the one of the secondary user-selectable objects.

According to another exemplary embodiment of the present invention, a user interface for interfacing with primary and secondary user-selectable objects comprising: primary and secondary user-selectable objects, wherein the secondary user-selectable objects are associated with a respective primary user-selectable objects; a display, wherein the secondary user-selectable objects associated with a respective primary user-selectable object are displayed upon the display when the respective primary user-selectable object is selected; and a cursor, wherein when the cursor is proximate of the secondary user-selectable object, the secondary user-selectable object is selected.

### BRIEF DESCRIPTION OF THE DRAWINGS

The accompanying drawings illustrate exemplary embodiments of the present invention, wherein:

FIG. 1 depicts a conventional remote control unit for an entertainment system;

FIG. 2 shows a typical drop down menu covering objects in a bookshelf view;

FIG. 3 shows a bookshelf view according to exemplary embodiments of the present invention;

FIG. 4 depicts an exemplary media system in which exemplary embodiments of the present invention can be implemented;

FIG. 5 shows a 3D pointing device according to an exemplary embodiment of the present invention;

FIG. 6 depicts an object with hover-buttons visible in a bookshelf view according to an exemplary embodiment of the present invention;

FIGS. 7A-7D depict an animation sequence for hover-buttons according to an exemplary embodiment of the present invention;

FIGS. 8A-8C illustrate an animation sequence for hover-buttons associated with a text object according to an exemplary embodiment of the present invention;

FIGS. 9A-9G illustrate an animation sequence for hover-buttons where a hover-button has a sub-menu according to an exemplary embodiment of the present invention;

FIG. 10 depicts thresholds associated with hover-buttons according to an exemplary embodiment of the present invention.

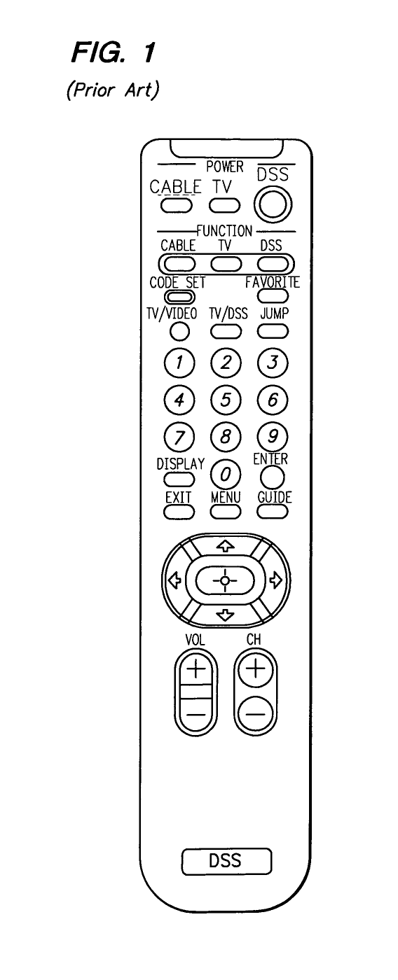

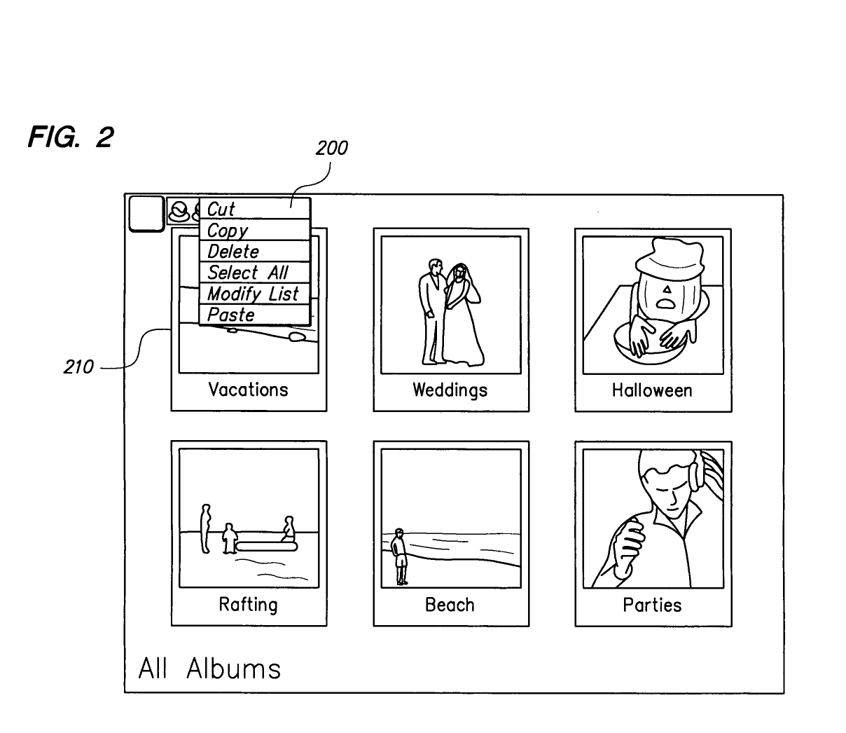

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims.

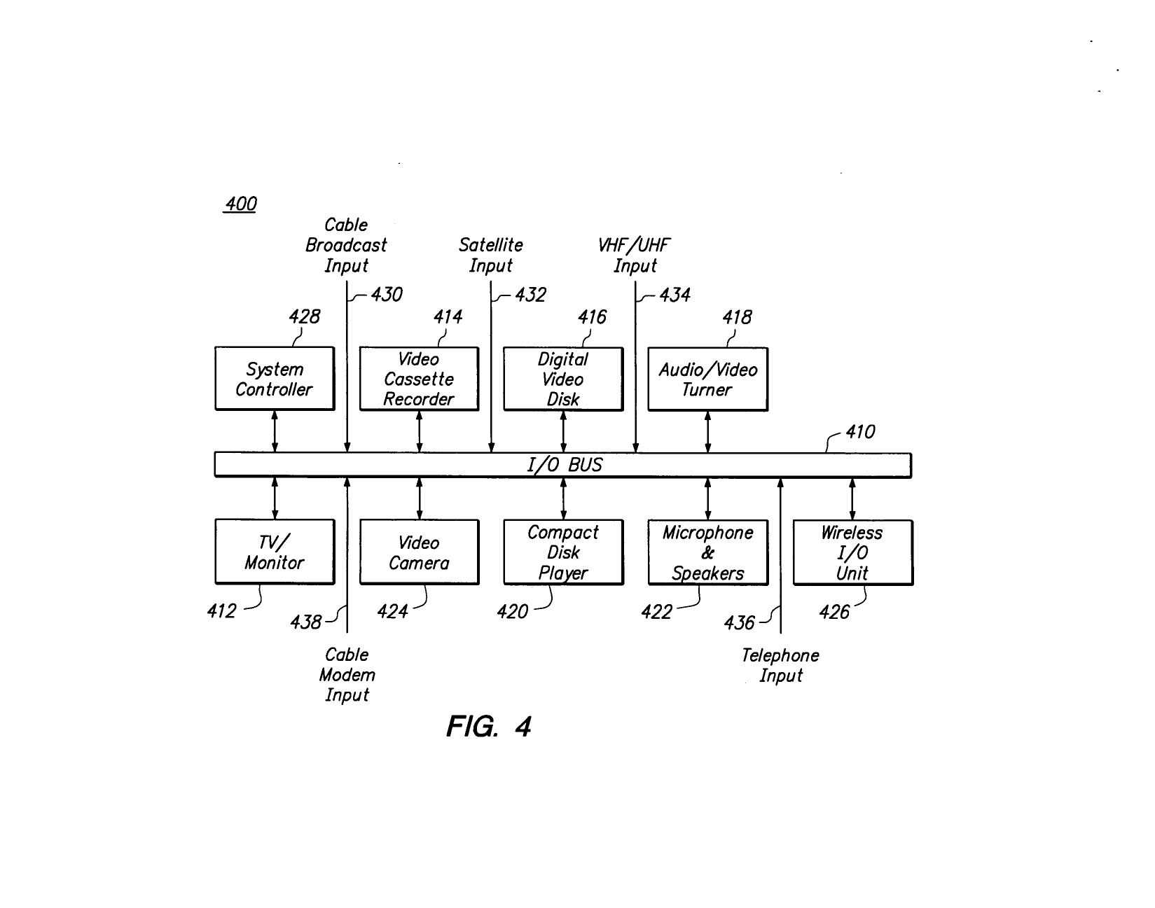

In order to provide some context for this discussion, an exemplary aggregated media system 400 in which the present invention can be implemented will first be described with respect to FIG. 4. Those skilled in the art will appreciate, however, that the present invention is not restricted to implementation in this type of media system and that more or fewer components can be included therein. Therein, an input/output (I/O) bus 410 connects the system components in the media system 400 together. The I/O bus 410 represents any of a number of different of mechanisms and techniques for routing signals between the media system components. For example, the I/O bus 410 may include an appropriate number of independent audio “patch” cables that route audio signals, coaxial cables that route video signals, two-wire serial lines or infrared or radio frequency transceivers that route control signals, optical fiber or any other routing mechanisms that route other types of signals.

In this exemplary embodiment, the media system 400 includes a television/monitor 412, a video cassette recorder (VCR) 414, digital video disk (DVD) recorder/playback device 416, audio/video tuner 418 and compact disk player 420 coupled to the I/O bus 410. The VCR 414, DVD 416 and compact disk player 420 may be single disk or single cassette devices, or alternatively may be multiple disk or multiple cassette devices. They may be independent units or integrated together. In addition, the media system 400 includes a microphone/speaker system 422, video camera 424 and a wireless I/O control device 426. According to exemplary embodiments of the present invention, the wireless I/O control device 426 is a 3D pointing device although the present invention is not limited thereto. The wireless I/O control device 426 can communicate with the entertainment system 400 using, e.g., an IR or RF transmitter or transceiver. Alternatively, the I/O control device can be connected to the entertainment system 400 via a wire.

The entertainment system 400 also includes a system controller 428. According to one exemplary embodiment of the present invention, the system controller 428 operates to store and display entertainment system data available from a plurality of entertainment system data sources and to control a wide variety of features associated with each of the system components. As shown in FIG. 4, system controller 428 is coupled, either directly or indirectly, to each of the system components, as necessary, through I/O bus 410. In one exemplary embodiment, in addition to or in place of I/O bus 410, system controller 428 is configured with a wireless communication transmitter (or transceiver), which is capable of communicating with the system components via IR signals or RF signals. Regardless of the control medium, the system controller 428 is configured to control the media components of the media system 400 via a graphical user interface as described below.

As further illustrated in FIG. 4, media system 400 may be configured to receive media items from various media sources and service providers. In this exemplary embodiment, media system 400 receives media input from and, optionally, sends information to, any or all of the following sources: cable broadcast 430, satellite broadcast 432 (e.g., via a satellite dish), very high frequency (VHF) or ultra high frequency (UHF) radio frequency communication of the broadcast television networks 434 (e.g., via an aerial antenna), telephone network 436 and cable modem 438 (or another source of Internet content). Those skilled in the art will appreciate that the media components and media sources illustrated and described with respect to FIG. 4 are purely exemplary and that media system 400 may include more or fewer of both. For example, other types of inputs to the system include AM/FM radio and satellite radio.

More details regarding this exemplary entertainment system and frameworks associated therewith can be found in the above-incorporated by reference U.S. Patent Application entitled “A Control Framework with a Zoomable Graphical User Interface for Organizing, Selecting and Launching Media Items”. Alternatively, remote devices in accordance with the present invention can be used in conjunction with other systems, for example computer systems including, e.g., a display, a processor and a memory system or with various other systems and applications.

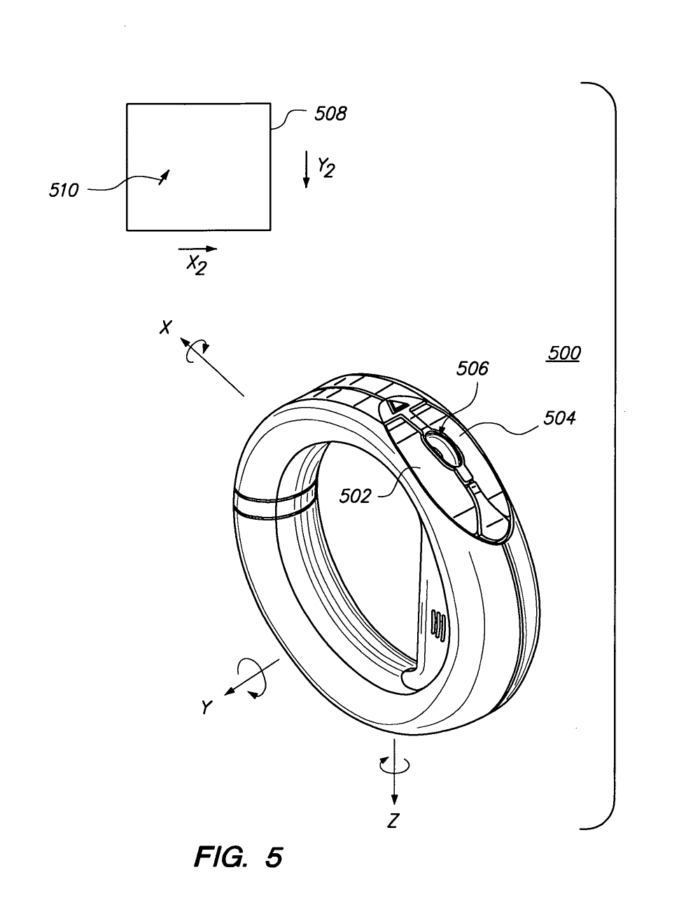

3D pointing devices enable the translation of movement, e.g., gestures, into commands to a user interface. An exemplary 3D pointing device 500 is depicted in FIG. 5. Therein, user movement of the 3D pointing can be defined, for example, in terms of a combination of x-axis attitude (roll), y-axis elevation (pitch) and/or z-axis heading (yaw) motion of the 3D pointing device 500. In addition, some exemplary embodiments of the present invention can also measure linear movement of the 3D pointing device 500 along the x, y, and z axes to generate cursor movement or other user interface commands. In the exemplary embodiment of FIG. 5, the 3D pointing device 500 includes two buttons 502 and 504 as well as a scroll wheel 506 (scroll wheel 506 can also act as a button), although other exemplary embodiments will include other physical configurations. According to exemplary embodiments of the present invention, it is anticipated that 3D pointing device 500 will be held by a user in front of a display 508 and that motion of the 3D pointing device 500 will be translated by the 3D pointing device into output which is usable to interact with the information displayed on display 508, e.g., to move the cursor 510 on the display 508. For example, rotation of the 3D pointing device 500 about the y-axis can be sensed by the 3D pointing device 500 and translated into an output usable by the system to move cursor 510 along the y₂ axis of the display 508. Likewise, rotation of the 3D pointing device 508 about the z-axis can be sensed by the 3D pointing device 500 and translated into an output usable by the system to move cursor 510 along the x₂ axis of the display 508. It will be appreciated that the output of 3D pointing device 500 can be used to interact with the display 508 in a number of ways other than (or in addition to) cursor movement, for example it can control cursor fading, volume or media transport (play, pause, fast-forward and rewind). Input commands may include operations in addition to cursor movement, for example, a zoom in or zoom out on a particular region of a display. A cursor may or may not be visible. Similarly, rotation of the 3D pointing device 500 sensed about the x-axis of 3D pointing device 500 can be used in addition to, or as an alternative to, y-axis and/or z-axis rotation to provide input to a user interface. The above described 3D pointing device system can be used in a GUI that uses hover-buttons as described below.

Hover-Buttons

Exemplary embodiments of the present invention describe how to improve interacting with objects in a graphical user interface (GUI) through the use of secondary user-selectable objects, some of which are referred to herein as “hover-buttons”.

Prior to describing specific details of these secondary user-selectable objects regarding, a brief description of an exemplary GUI in which they can be deployed is presented. The GUI contains one or more target objects (also referred to herein as graphical objects or primary user-selectable objects). The target objects can be presented and organized in many different ways on a display such as: (1) single buttons or zoomable objects arbitrarily positioned on the screen, (2) one dimensional lists of buttons or zoomable objects which may be scrollable, (3) two dimensional grids of objects possibly scrollable and pannable, (4) three dimensional matrices of objects possibly scrollable and (5) various combinations of the above. It may be desirable for some GUI objects to be immediately available at all times because of their functionality. In the exemplary GUIs described herein, objects with hover-buttons are presented in a bookshelf format, however as described above other presentations are possible.

According to exemplary embodiments of the present invention, a cursor is used to indicate the current location of interest in the user interface associated with movement of a corresponding pointing device. When the cursor enters the area occupied by a target object and hovers within the area for a predetermined amount of time, such as 100 ms to 1000 ms, that object is highlighted. Note that hovering includes, but is not limited to pausing, such that the cursor can still be moving and trigger a change in object focus. Highlighting is visible through a color change, a hover-zoom effect, enlargement or any other visual method that makes the object over which the cursor has paused distinguishable from other objects on the display. The highlighted object is the object on the GUI that has the focus of both the user and the system. Hover-button(s) can be associated and attached to the currently highlighted (or focused) object to enable the user to actuate, or otherwise further interact with, that object. These attached hover-buttons make it clear to a user which object the hover-buttons are associated with.

In this specification, an object can gain the focus of the system and the user, e.g., by having a cursor hover thereover, which may be different from selection of that object. Selecting an object typically involves some form of actuation which can, for example, execute a function related to the object which currently has the focus of the system. According to some exemplary embodiments described herein, a cursor moves over an object and the object enlarges, or otherwise provides feedback to the user that that object has gained focus (e.g., it is highlighted). The user may then perform an action such as, for example, “clicking” on the object. This clicking selects the object and activates a function associated with the object. For example, if the focused object was a movie cover, and the user clicked on the focused object an action such as playing the movie could occur. Alternatively, a user may change the system's focus to another object on the user interface without selecting or actuating the object which previously had the user and the system's focus.

Prior to describing examples using hover-buttons with user-selectable objects, a description of some of the exemplary features of hover-buttons is presented. According to exemplary embodiments of the present invention, hover-buttons are a type of secondary user-selectable object that are associated with, and often geographically attached to, a primary user-selectable object, such as a picture in a picture organizing portion of a user interface. Hover-buttons can be geographically disbursed around the edge of the associated target object in order to increase the distance between the hover-buttons associated with the same target object so that it is easier for a user to point and gain the focus of one hover-button over another hover-button. To achieve this geographical disbursement, hover-buttons can, for example, be located at geographic corners on the edge of an object. A typical pattern of cursor movement is from the center of the hovered target object to one of the corners where a hover-button is located. The effect generated is a single vector movement in one of four directions relative to the hovered object. These same relative movements towards corners of target objects tend to become a habit forming gesture that simplifies using the GUI. Another exemplary feature of hover-buttons is that hover-buttons can become visible only when the object to which they are attached has the focus. Upon losing the focus of the object, the hover-buttons then become invisible. Also as a cursor comes near a hover-button, the hover-button enlarges and upon the cursor moving away from the hover-button, the hover button shrinks in size to allow the associated object to become clearly visible. Additionally, only one hover-button tends to be enlarged at a time to increase the ease of selection for a user. Using combinations of these exemplary features of hover-buttons, examples of using hover-buttons are presented below.

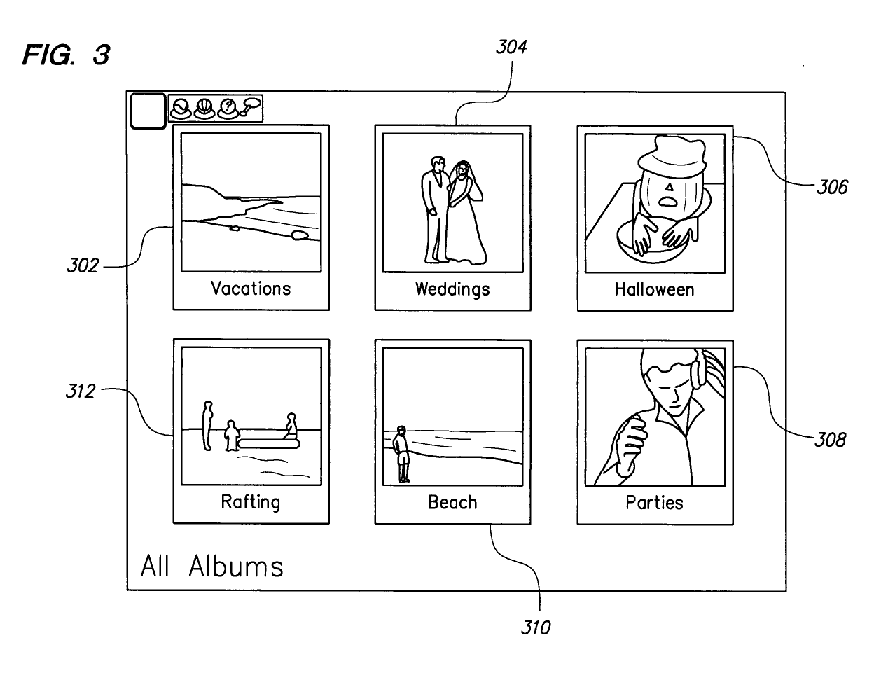

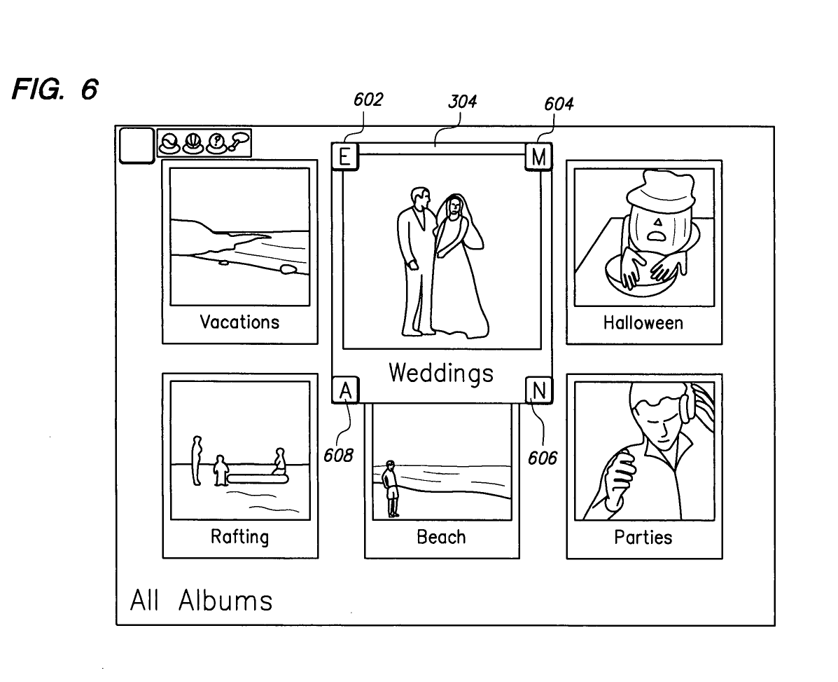

According to exemplary embodiments of the present invention, hover-buttons can be associated with objects in a GUI. As shown in FIG. 3, objects 302, 304, 306, 308, 310 and 312, in this example images of pictures, are presented in a bookshelf view. None of these objects 302, 304, 306, 308, 310 and 312 currently have the focus of the system or the user. When a cursor (not shown) is moved over an object, the object is enlarged and the associated hover-buttons become visible. This can be seen in FIG. 6, where object 304 has gained the focus by a cursor (not shown) hovering over object 304 and is therefore enlarged as a result of a hover-zoom animation. Additionally, four hover-buttons 602, 604, 606 and 608 are now visible and appear attached to object 304. In this exemplary embodiment, when hover-buttons initially become visible they are in a minimized format so as to not obscure the object 304 to which they are attached, and to minimize obscuring other objects in the GUI.

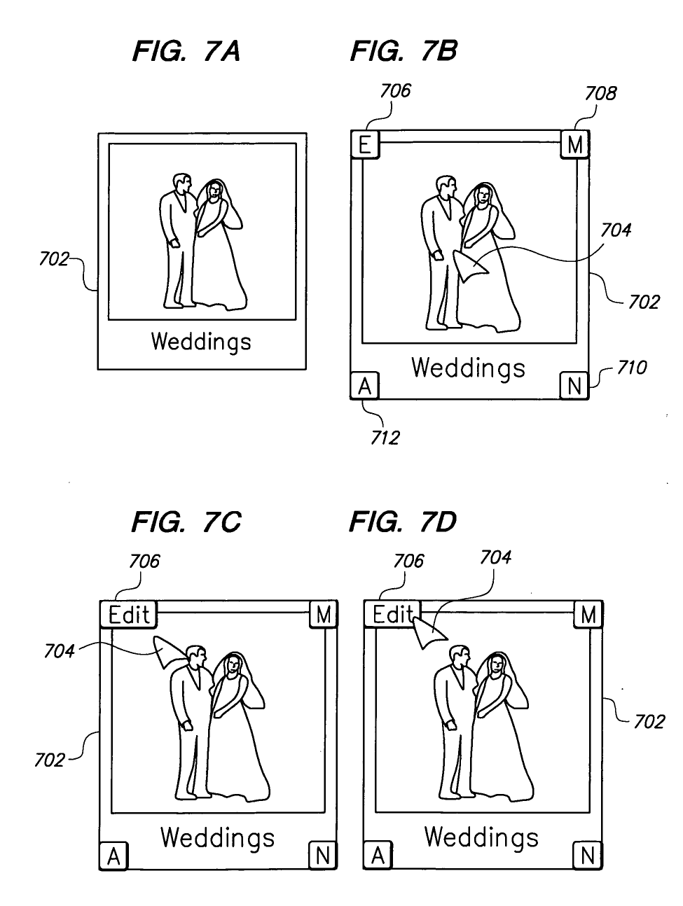

According to an exemplary embodiment of the present invention, an animation sequence is used to illustrate the flow of actions from having an object on the screen to enabling or actuating a hover-button. This exemplary animation sequence is illustrated in FIGS. 7A-7D. Initially, as shown in FIG. 7A, there is an object 702. When cursor 704 is moved over object 702 and hovers, object 702 becomes enlarged and the hover-buttons (706, 708, 710 and 712) become visible as shown in FIG. 7B. As cursor 704 moves toward a particular hover-button, that hover-button will enlarge. For example, as shown in FIG. 7C, when cursor 704 is moved towards hover-button 706, hover-button 706 enlarges. This enlarged hover-button 706 can be seen by comparing FIG. 7B to FIG. 7C. In FIG. 7B, hover-button 706 is a relatively small, square shaped button showing the letter “E”. Upon expansion, as shown in FIG. 7C, the hover-button 706 is a larger rectangular shaped button displaying the word “Edit”. The hover-button 706 gains the focus upon moving cursor 704 over top of hover-button 706 as shown in FIG. 7D. One method for triggering graphic feedback and/or execution of a function associated with hover-button 706 is to click hover-button 706 with the pointing device. Additionally, if hover-button 706 itself had hover-buttons associated with it, these new hover-buttons would become visible once the cursor was over top hover-button 706. In this exemplary embodiment, only one object is shown for simplification, whereas in most applications, there will be many objects in the bookshelf view.

According to another exemplary embodiment of the present invention, hover-buttons can be applied to text objects as shown in FIGS. 8A-8C. FIGS. 8A-8C additionally show an exemplary animation sequence involved in text object 802 gaining the focus and activating a hover-button. FIG. 8A shows an exemplary text object 802. In FIG. 8B text object 802 has gained the focus by moving a cursor (not shown) which makes hover-buttons (804, 806 and 808) visible. By moving the cursor (not shown) toward hover-button 804, hover-button 804 expands as shown in FIG. 8C, revealing the “Delete” hover-button label. Additionally, according to an exemplary embodiment of the present invention, the background coloration of a hover-button can be either transparent or translucent to minimize obscuring information. Note that in this exemplary embodiment of the present invention, when the target object gains the focus, i.e., text object 802, a graphical selection effect (outline 810) is displayed rather than enlargement of the target object as in the embodiment of FIG. 7B.

One benefit of the afore-described techniques is to create a simple GUI. One expectation of a simple GUI is to have a reduced set of needed functions for use in the simple GUI. Accordingly, in one exemplary embodiment of the present invention, an object will have a maximum of four hover-buttons associated with each target object. Each hover button corresponds to a different function that can be performed in association with the object.

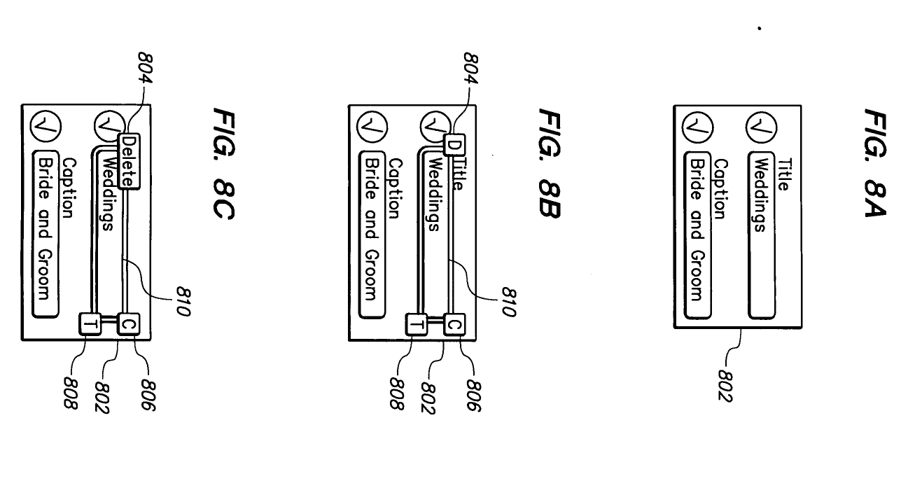

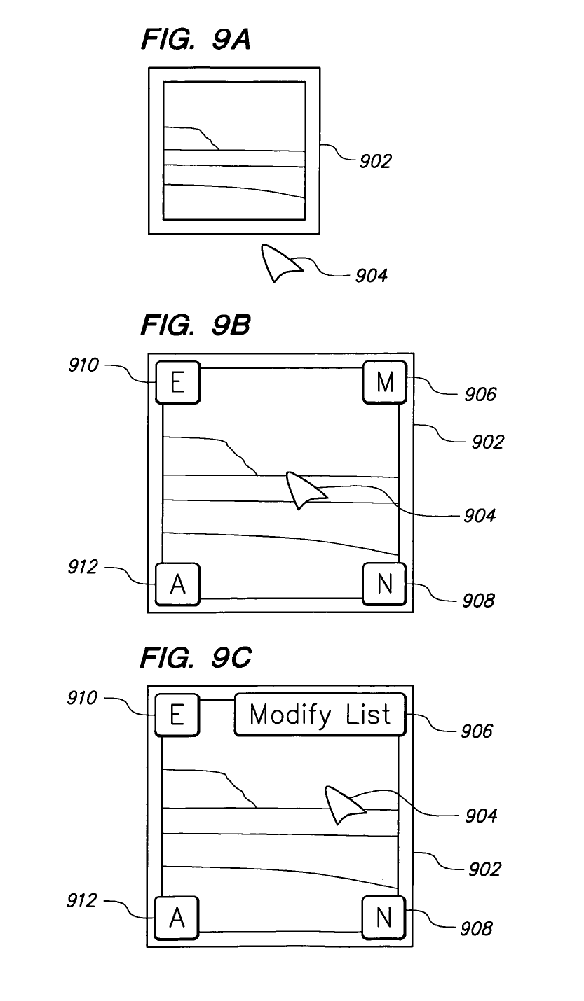

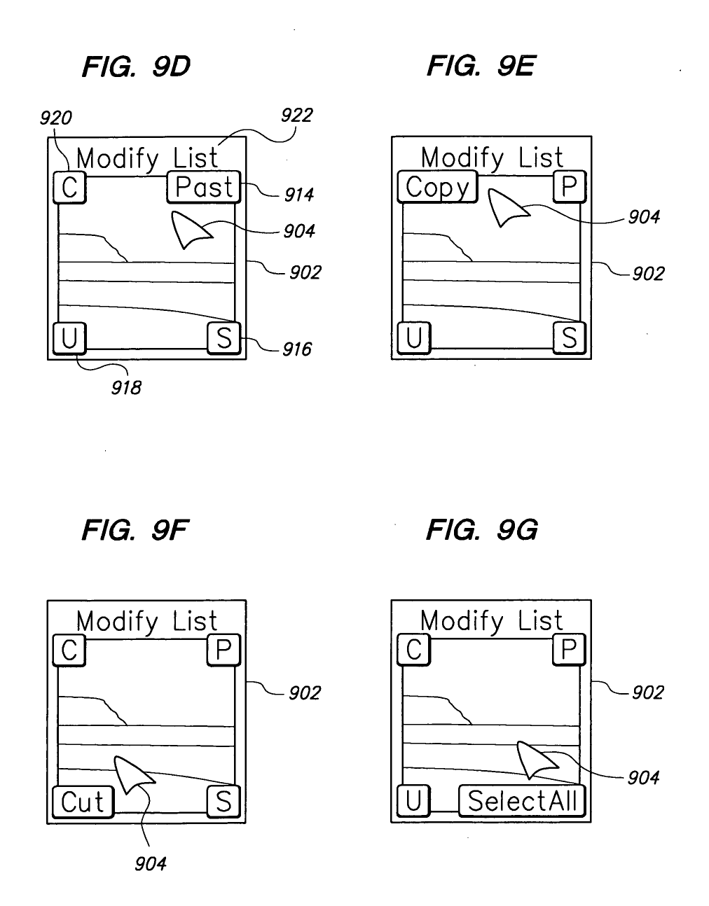

According to other exemplary embodiments of the present invention more than four functions can be associated with an object. To achieve this functionality, an exemplary embodiment of the present invention allows a hover-button to have a sub-menu. An exemplary animation sequence involving a hover-button with a sub-menu is shown in FIGS. 9A-9G. FIG. 9A shows an image object 902 that does not have the focus and a cursor 904. In FIG. 9B, the cursor 904 is hovering over the now focused upon image object 902, which results in the hover-buttons (906, 908, 910 and 912) becoming visible. FIG. 9C shows the cursor 904 moving towards the upper right corner of image object 902 which causes hover-button 906 to enlarge. As the cursor 904 gets closer to hover-button 906, the sub-menu becomes visible as seen in FIG. 9D, i.e., the new hover-buttons (914, 916, 918 and 920) for the sub-menu become visible. Additionally as shown in FIG. 9D, when the sub-menu becomes visible, the sub-menu name “Modify List” 922 moves just above the object 902 to remind the user that he or she is in a sub-menu. Since the cursor 904 is close to hover-button 914, hover-button 914 is enlarged as seen in FIG. 9D. FIGS. 9E-9G show the enlarged, sub-menu hover-buttons located near each corner of object 902 when cursor 904 is in proximity to the hover-button, as well as the shrinking of a hover-button when cursor 904 moves away from the hover-button.

According to another exemplary embodiment of the present invention, instead of using the animation sequence described above, a hover-button can reach its maximum or minimum size instantaneously based upon the cursor's location.

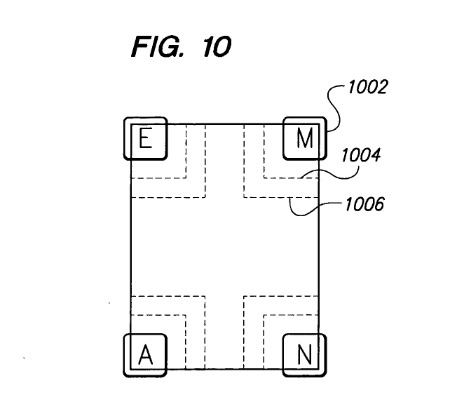

As described above, hover-buttons can become enlarged when a cursor moves towards a hover-button. Hover-buttons can have associated area thresholds that, when crossed, trigger actions related to the hover-button. As illustrated in FIG. 10, hover-button 1002 has two area thresholds (typically not visible to the GUI user) (1004 and 1006) associated with it. When a cursor (not shown) crosses over any portion of threshold 1006, the sub-menu associated with hover-button 1002 gains the focus and enlarges. When the cursor (not shown) crosses over any portion of threshold 1004, hover-button 1002 (if any) is displayed. Similar thresholds are associated with the other hover-buttons. In order to leave the submenu, the user needs to move the cursor outside of the primary object's boundaries.

According to other exemplary embodiments of the present invention, hover-buttons can gain focus based on a movement gesture made by the user depicted by the cursor motion on the screen. For example, after an object has gained the focus, when the cursor is moved towards a hover-button, that hover-button gains the focus and becomes enlarged.

According to another exemplary embodiment, scrolling can be used in conjunction with hover-buttons. Each primary user-selectable object in, e.g., a bookshelf view would have a scrolling order number assigned to it, with one of the objects in each view being considered the starting object for scrolling. Additionally, the hover-buttons associated with each object in the bookshelf view would be part of the predetermined scrolling sequence. In an exemplary scrolling order, the scrolling order would be to visit the primary object then visit each hover-button associated with the primary object followed by moving to the next primary object. The next object in the scrolling order would gain the focus of the system and the user with one index rotation of the scroll-wheel.

Numerous variations of the afore-described exemplary embodiments are contemplated. The above-described exemplary embodiments are intended to be illustrative in all respects, rather than restrictive, of the present invention. Thus the present invention is capable of many variations in detailed implementation that can be derived from the description contained herein by a person skilled in the art. All such variations and modifications are considered to be within the scope and spirit of the present invention as defined by the following claims. No element, act, or instruction used in the description of the present application should be construed as critical or essential to the invention unless explicitly described as such. Also, used herein, the article “a” is intended to include one or more items.

What is claimed is:

1. A method for interacting with primary and secondary user-selectable objects in a graphical user interface comprising the steps of:
associating secondary user-selectable objects with primary user-selectable objects;
displaying secondary user-selectable objects associated with a respective primary user-selectable object when said respective primary user-selectable object is selected; and
focusing upon one of said secondary user-selectable objects when a cursor is proximate of said one of said secondary user-selectable objects.

2. The method of claim 1, wherein hovering said cursor over said respective primary user-selectable object focuses upon said primary user-selectable object.

3. The method of claim 2, further comprising the step of enlarging said respective primary user-selectable object to indicate its having focus.

4. The method of claim 2, further comprising the step of outlining said respective primary user-selectable object to indicate its selection.

5. The method of claim 1, further comprising the step of deselecting said respective primary user-selectable object by moving said cursor away from said respective primary user-selectable object.

6. The method of claim 5, wherein said step of deselecting said primary user-selectable object renders said secondary user-selectable objects invisible.

7. The method of claim 1, wherein said secondary user-selectable objects are located proximate geographic corners of an edge of said respective primary user-selectable object.

8. The method of claim 1, wherein said secondary user-selectable objects are geographically disbursed around said edge of said primary user-selectable object.

9. The method of claim 1, wherein only one of said secondary user-selectable objects is enlarged at a time.

10. The method of claim 1, wherein said primary user-selectable object is either a text style primary user-selectable object or an image style primary user-selectable object.

11. The method of claim 1, wherein said secondary user-selectable objects have sub-menus.

12. The method of claim 11, wherein crossing a first threshold results in display of said secondary user-selectable objects and crossing a second threshold results in display of a sub-menu associated with a closest one of said secondary user-selectable objects.

13. The method of claim 11, wherein said sub-menus contain secondary user-selectable objects.

14. The method of claim 1, wherein clicking upon said secondary user-selectable object triggers graphic feedback and execution of a function.

15. The method of claim 7, wherein said secondary user-selectable objects have a translucent background.

16. The method of claim 7, wherein said secondary user-selectable objects have a transparent background.

17. The method of claim 1, wherein said secondary user-selectable objects are hover-buttons.

18. The method of claim 1, wherein said respective primary user-selectable object is selected when said cursor hovers over said primary user-selectable object for a predetermined amount of time.

19. A user interface for interfacing with primary and secondary user-selectable objects comprising:
primary and secondary user-selectable objects, wherein said secondary user-selectable objects are associated with a respective primary user-selectable objects;
a display, wherein said secondary user-selectable objects associated with a respective primary user-selectable object are displayed upon said display when said respective primary user-selectable object is selected; and
a cursor, wherein when said cursor is proximate of said secondary user-selectable object, said secondary user-selectable object is selected.

20. The user interface of claim 19, wherein hovering said cursor over said respective primary user-selectable object selects said primary user-selectable object.

21. The user interface of claim 20, further comprising the step of enlarging said respective primary user-selectable object to indicate its selection

22. The user interface of claim 20, further comprising the step of outlining said respective primary user-selectable object to indicate its selection.

23. The user interface of claim 19, further comprising the step of deselecting said respective primary user-selectable object by moving said cursor away from said respective primary user-selectable object.

24. The user interface of claim 23, wherein said step of deselecting said primary user-selectable object renders said secondary user-selectable objects invisible.

25. The user interface of claim 19, wherein said secondary user-selectable objects are located proximate geographic corners of an edge of said respective primary user-selectable object.

26. The user interface of claim 19, wherein said secondary user-selectable objects are geographically disbursed around said edge of said primary user-selectable object.

27. The user interface of claim 19, wherein only one of said secondary user-selectable objects is enlarged at a time.

28. The user interface of claim 19, wherein said primary user-selectable object is either a text style primary user-selectable object or an image style primary user-selectable object.

29. The user interface of claim 19, wherein said secondary user-selectable objects have sub-menus.

30. The user interface of claim 29, wherein crossing a first threshold results in display of said secondary user-selectable objects and crossing a second threshold results in display of a sub-menu associated with a closest one of said secondary user-selectable objects.

31. The user interface of claim 29, wherein said sub-menus contain secondary user-selectable objects.

32. The user interface of claim 19, wherein clicking upon said secondary user-selectable object triggers graphic feedback and execution of a function.

33. The user interface of claim 26, wherein said secondary user-selectable objects have a translucent background.

34. The user interface of claim 26, wherein said secondary user-selectable objects have a transparent background.

35. The user interface of claim 19, wherein said secondary user-selectable objects are hover-buttons.

36. The user interface of claim 19, wherein said respective primary user-selectable object is selected when said cursor hovers over said primary user-selectable object for a predetermined amount of time.
